(19) United States
(12) Patent Application Publication
(10) Pub. No.: US 2011/0040656 A1
(43) Pub. Date: Feb. 17, 2011

(54) SYSTEM AND METHOD FOR GENERATING PREDICTIONS OF PRICE AND AVAILABILITY OF EVENT TICKETS ON SECONDARY MARKETS

(76) Inventors: Jon D. Groetzinger, Brooklyn, NY (US); Russell P. D'Souza, Morristown, NJ (US)

Correspondence Address: James C. Scott;Roetzel & Andress, Suite 900, 1375 East Ninth Street, Cleveland, OH, 44114, US

(21) Appl. No.: 12/853,422

(22) Filed: Aug. 10, 2010

Related U.S. Application Data
(60) Provisional application No. 61/233,217, filed on Aug. 12, 2009.

(51) Int. Cl. G06Q 30/00

(52) U.S. Cl. 705/27.1; 705/306

(57) ABSTRACT

A system and method is provided for predicting future price and availability of event tickets on the primary and secondary market and providing buyers with a recommendation as to when to purchase the event tickets at the lowest possible cost or, for sellers, when to sell the tickets at the highest possible price. Data is collected and used to generate statistics about the historical price and availability of event tickets. This data is further used to provide forecasts about the future price and availability of event tickets, including the probability of a sell out for events currently on sale and events not yet on sale. The system makes predictions by differentially weighing factors, both economic and non-economic, that influence the price trajectory and availability of event tickets. The system further includes a self-training mechanism that evolves behaviors based on previous price predictions thereby increasing the systems ability to accurately predict future event ticket prices.

### RELATED APPLICATIONS

This application claims priority to U.S. Provisional Patent Application No. 61/233,217 filed on Aug. 12, 2009, which is incorporated in its entirety herein by reference.

### FIELD OF THE INVENTION

The present invention and related disclosure is in the field of forecasting and more specifically is directed to a system and method for forecasting price and availability of event tickets on the secondary market.

### BACKGROUND OF THE INVENTION

The secondary market for sports, concert, theater, and other event tickets (hereinafter referred to collectively as “event tickets”) encompasses all event tickets sold by people or companies other than the original vendor of the tickets. The price and availability of event tickets on the secondary market often varies significantly as the event approaches. Ideally, consumers would like to buy secondary event tickets at their lowest price. Secondary ticket sellers would however, like to sell their event tickets at the highest price. There is currently little or no means for either consumers or secondary ticket sellers to predict future event ticket prices and determine the best ticket values for seats in different sections of a forum.

Additionally, neither consumers nor secondary ticket sellers can reasonably predict when an event is likely to sell out. If an event is likely to sell out, consumers may opt to purchase tickets at higher prices than they might otherwise pay to ensure they will have a ticket to the event. Similarly, secondary ticket sellers may opt to raise prices higher than they might otherwise to ensure they reap a higher profit while tickets are still available.

### SUMMARY OF THE INVENTION

A method is described herein for providing a user with a substantially accurate price forecast for at least one future event ticket on the secondary market and providing the user with the optimal time in which to purchase or sell the at least one future event ticket so that the purchase price is minimized or the selling price is maximized. The method includes: receiving a user request via a website identifying at least one future event ticket for which the user is interested; accessing economic and non-economic data that will have an effect on the price of the at least one future event ticket; determining the price forecast for the at least one future event which indicates to the user whether the future event ticket should be purchased or sold at the present time or at sometime in the future; and providing the user with a list of secondary market offers for the at least one future event ticket and the price forecast for the at least one future event ticket. If the price forecast indicates that the at least one future event ticket should be purchased or sold at the present time, the system will provide the user the ability to purchase or sell the at least one future event ticket. If the price forecast indicates that the at least one future event ticket should be purchased or sold at a later date, the system will still provide the user with the ability to purchase or sell the at least one future event ticket but will also provide the user with the opportunity to receive a communication alert when the ticket reaches the lowest predicted purchase price or highest predicted selling price.

Another aspect of the present invention is directed to a system for providing users with a future price and availability forecast for event tickets on the secondary market. The system includes means for searching the internet to locate and collect information relevant to events and event ticket sales; at least one data storage device for saving and storing collected information relevant to events and event ticket sales for a plurality of events; a website which provides means for interacting with one or more users by providing users with the ability to search for, select or enter a particular event, request current availability and pricing information for the event, receive event information and link to one or more secondary market websites to purchase tickets to the event; and a computer-readable medium having instructions for determining the future availability and pricing trend of user requested event tickets on the secondary market.

Still another aspect of the invention describes an event ticket system that upon request from a user provides the current price and availability of one or more event tickets on the secondary market and provides the user with the optimal time at which to purchase the one or more event tickets in order to minimize the cost. The system includes means for gathering and storing historical sales data for a plurality of future event tickets; means for gathering and storing non-sales data that may affect the price of the plurality of future event tickets; means for determining a daily forecast of the future availability and price trajectory of the one or more event tickets; means for providing the user with the daily forecast; means for providing the user with the option to purchase one or more event tickets from the secondary market; and means for providing the user with the option of setting up a system alert which will notify the user when the one or more event tickets have reached a forecasted minimum purchase price.

### DESCRIPTION OF THE DRAWINGS

FIG. 1 is a flow chart diagram illustrating an embodiment of the system and method for generating predictions of price and availability of event tickets on secondary markets.

### DETAILED DESCRIPTION OF PREFERRED AND ALTERNATE EMBODIMENTS

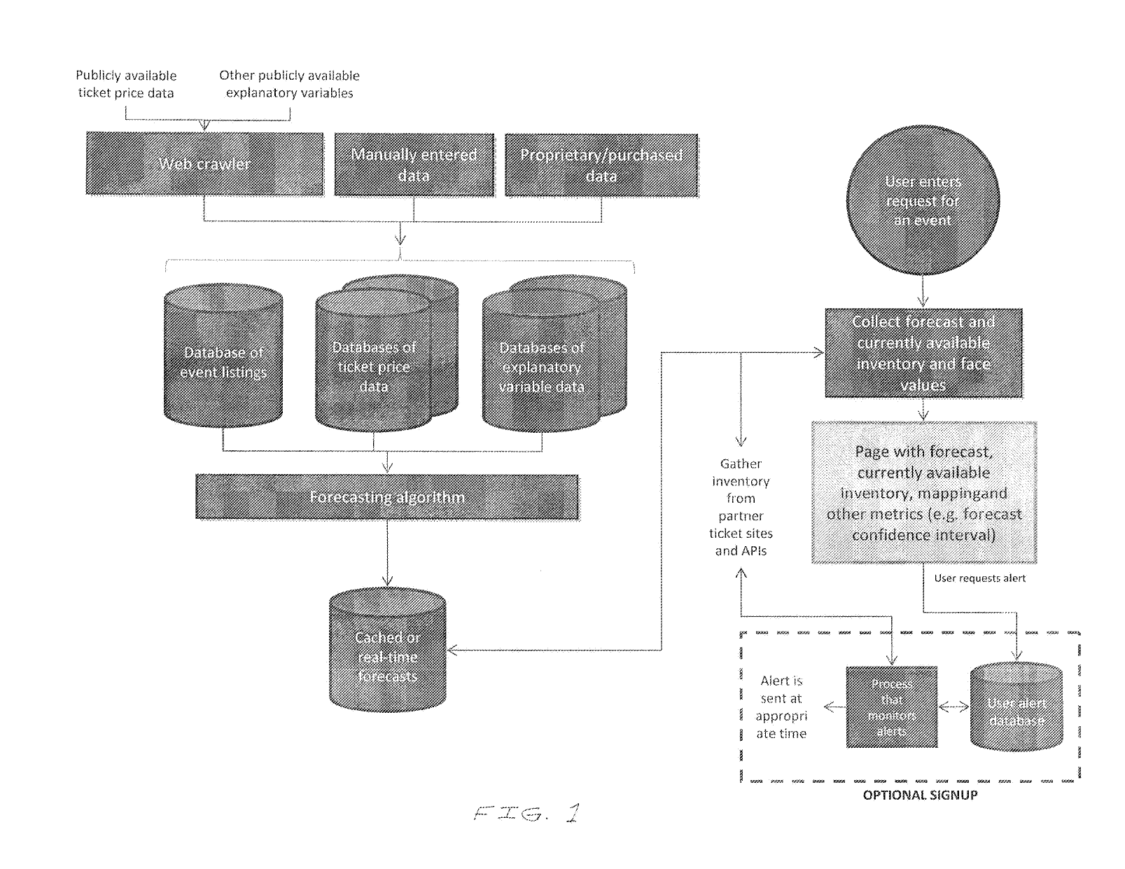

A system (hereinafter referred to as “the system”) is described herein including a working combination of software, hardware, mathematical algorithms and data communications devices which are configured and programmed to gather and use a variety of information to predict or forecast the future availability and price of event tickets on the secondary market. A general overview of the system is shown in the flow chart of FIG. 1. The system includes computer readable instructions to gather and store the data needed to provide price and availability predictions and to manipulate this data to provide predictions to users. On a periodic basis, preferably a daily basis (or more frequently), the system calculates a forecast or prediction based on the stored information and saves it within the system so that each future event is assigned a daily prediction or forecast of the future availability and price of event tickets to said event on the secondary market. Alternatively, the forecasts may be calculated in real time. Based upon a request from a user regarding a specific event, the system returns the corresponding availability and price prediction or forecast for the requested event. The system benefits buyers of event tickets on the secondary market by providing the buyer with predictive information that can assist the buyer in timing his/her ticket purchase so that he/she purchases the ticket at the predicted optimal time, at the predicted lowest possible price. The system also benefits sellers of event tickets on the secondary market by providing the seller with the predicted optimal time to sell, at the predicted highest attainable price.

One way the system gathers pertinent information is by using web bots or crawlers that search the internet on a daily basis (or more frequently) using keywords or event IDs to locate and capture publicly available information relevant to events and event ticket sales. For example, the bots may search secondary market websites in search of specific information about available event tickets and transacted sales. In addition to searching secondary market websites for current price and previous sale information, the bots also search other online sources for other relevant information that may have an effect on event ticket prices. For example, as it pertains to tickets to a Major League Baseball (MLB) game, relevant data includes, but is not limited to: the win/loss record of the teams playing the game; the performance metrics of individual players; league standings; weather predictions; attendance statistics; offered team or ballpark promotions; venue capacity; venue location; win/loss streaks; location of a game within a home stand; and the face value of each individual seat. Because the price of event tickets on the secondary market can be volatile, in some situations, historical pricing and current offering prices alone may not produce an accurate forecast or prediction of future selling prices. For example, MLB playoff game tickets may be considered in high demand based on previous MLB playoff ticket sales and high initial sales prices on the secondary market. However, weather predictions may indicate unusually extreme high or low temperatures that may influence ticket sales by decreasing the price. If the prediction was made based on historical economic (price, sales) data alone, the future prediction may indicate that the ticket price is unlikely to decline or likely to increase as the event draws near, thereby suggesting that a user should purchase the ticket immediately. In actuality, when the predicted extreme weather conditions are considered, the price may actually decrease substantially as the event approaches. The method of using a combination of economic and non-economic data yields a more robust and accurate forecast. For other event types, such as concerts, such relevant information may include, but is not limited to: the length of the artist's tour; how recently the artist visited the city; how recently the artist released new music; online popularity metrics; and the popularity of the opening act. Additional information may include: the time of the event; the day of the week; the time between the ticket sale and the event; and the current demand (e.g., ratio of the average price/face value). The information obtained by the web bots is maintained in a database or other large capacity data storage medium and used to generate statistics about the historical price and availability of future event tickets. The data is further used to provide forecasts about the future price and availability of event tickets, including the probability of a sell out for events currently on sale and future events not yet on sale. In addition to using web bots or crawlers to obtain economic and non-economic data, this information may also be purchased and manually entered into the system.

The forecasting algorithms may utilize one or more econometric models to arrive at the user-requested forecasting information as it relates to a particular event. An example of such model includes, but is not limited to regression analysis, including linear and non-linear, multiple, and ordinary least squares regression. These methods may use a number of interaction terms between factors and time variables to determine how the magnitude of factors change over time. Other methods employed may include machine learning, statistical-based learning, reinforcement-based learning, rule learning, and/or ensemble-based learning. These methods allow the system to evolve behaviors based on the myriad of data contained in the database and improve forecasts over time as it is provided additional data. The more predictions the system makes, the more data is available, thereby increasing the system ability to accurately predict future event ticket availability and price.

Users may interact with the system by visiting a website where they may search for events in which they are interested and receive predictions about the future price trajectory and availability of tickets for the events. Users may use search criteria such as team name, artist, venue or city to find events nationwide. The system includes a process for identifying the best deals available on the secondary market by comparing the asking price to a ticket's face value and location within the venue. The best available tickets are aggregated from different secondary markets onto a single page that is returned to the user in response to the user selected search criteria. The process provides users with the best deals while expending minimal effort. The system algorithms consider the face value of the ticket, the current price offering for the ticket and the location of the seat within the appropriate venue to determine a rating of the quality of the deal. Worse seats must be significantly cheaper than good seats in order to be considered a good deal. The system selects between one and ten tickets that are the best offerings. The list however, includes all available tickets, the location of the seating within the venue, and the corresponding current offered ticket price. The user has the option of purchasing available tickets, in which case, the system will automatically direct the user to the appropriate secondary market event ticket website. The results page may additionally include information about the particular venue in which the event will be held, such as an interactive map of the venue's seating arrangement showing available seats and the associated current purchase price, and a historical price graph showing data from actual transactions that took place on various secondary ticket markets. Users will also be provided with a general forecast that informs the users whether it is a good time to purchase the desired tickets. The system assigns one of seven possible forecasts to each event, including sharp decrease, moderate decrease, steady prices, moderate increase, sharp increase, hump and trough to indicate whether the user should wait to purchase the tickets or whether the tickets should be purchased at that time. A “hump” is a situation where the system expects the price to rise in the short term and then fall below its current price level. A “trough” is a situation where the system expects the price to drop in the short term and then rise above its current price level. For both humps and troughs, the user should delay the ticket purchase in order to get the best price. The system may also provide the user with additional information such as the average listing price and average listing price as a percentage of the face value of the ticket. The system may additionally provide a specific price forecast (e.g., “prices for this event are predicted to drop to $54.67”) and a corresponding confidence interval. In addition to accessing future event ticket forecast data through a website, a forecast may also be accessed via a mobile application, desktop software, or by any other method that is known to those skilled in the art.

The system also provides the user with the option of setting up an alert in the system. Users who have signed up for the notification service will receive a notification of the optimal time to purchase the desired tickets, via email, SMS alert or other suitable communication method. The system determines the predicted optimal time to purchase the tickets by considering the future price forecast for the event and the event's forecasted ticket availability. When users sign up to receive alerts, they are given the option of tailoring the timing of the alert to their individual preferences by indicating how much they care about price, ease of finding a ticket, and the amount of time before an event they are comfortable waiting to purchase the ticket. In cases where the forecast indicates that the price will constantly decline all the way until the date and time of the event, the system will send an email alert no later than three days before the event to give the user time to procure the tickets. The email may also indicate whether the forecast predicts that the price will continue to decline. The user may also be optionally alerted when the desired tickets are available below a certain price, as indicated by the user. The user may alternatively give the system permission to buy or sell a specific ticket once it reaches a certain price or other pre-determined criteria. For example, if the lowest ticket price is currently $200, the user can set a limit order for $150 so that if the ticket becomes available at that price, the system will automatically purchase the ticket on behalf of the user. The user may specify the maximum purchase price, desired quantity of tickets, quality of seating (location) within the corresponding venue, or the time of the ticket purchase.

In addition to assisting buyers determine the optimal time in which to purchase event tickets on the secondary market at the lowest possible price, the system is also capable of assisting ticket brokers or other secondary ticket sellers to maximize profits by optimally timing their buying and reselling of event tickets. Sellers may enter into the system their entire inventory of tickets and also tickets they are interested in purchasing with the intent of reselling into the system. The system will then alert the seller at the predicted optimal time to sell each ticket or to purchase each ticket intended for resale. The optimal time is determined by the prediction of the ticket's future price trajectory and difficulty in selling the ticket. Sellers are able to customize the system recommendations by indicating their different risk tolerances in various aspects of the selling process. The system also analyzes the tickets that the seller is considering purchasing with the intent of reselling, and indicates to the seller the profitability of each transaction. Sellers can also benefit from the system's ability to forecast the probability that an event will sell out. This applies to both event tickets that are already on sale and event tickets that have yet to go on sale. Once an event sells out, the price of event tickets typically spikes on the secondary market. Sellers can use this prediction to identify profitable opportunities. Another aspect of this option is that season ticket holders may enter a season's worth of tickets and receive recommendations from the system as to which tickets to keep and which to sell based on maximizing profitability by maximizing the selling price. The system aids bulk ticket holders in obtaining the most value for their entire portfolio of tickets by recommending which tickets to sell and when to sell them to receive the highest price possible.

Additionally, primary market ticket vendors such as sports teams, concert promoters, theater venues, etc. may also benefit by using the system to optimally price their event tickets based on historical and forecasted prices and availability in the secondary market. Primary vendors can determine whether their tickets have been or will be selling for above or below face value on the secondary market, thereby helping to determine if they are pricing their event tickets above or below a level that would maximize profits.

Revenue plans for implementing the system can vary. For example, the ability for a user to search for a particular event and receive forecasting information regarding the event may be provided at no cost to the user. If the user makes a purchase on a secondary ticket seller's website which he/she was directed to by the system, then the owner/operator of the system will receive a certain percentage of the sale from either the user or the primary or secondary ticket seller. Alternatively, the system may charge a per transaction fee to users requesting forecasting information about one or more events. Another way in which the system may generate revenue is by charging a fee for supplementary services, which can be any service beyond providing the event ticket forecast, such as setting up an alert, setting automatic purchase criteria, purchasing an optional insurance policy or an option to purchase (discussed below). The system may also charge a fee for forecasting an entire lot of event tickets entered by a broker or other primary or secondary market seller and for determining and alerting the seller of the optimal selling time for each event ticket. Another revenue generating option is for the owner/operator to charge a one-time or periodic subscription fee.

The system of the present invention and related disclosure may contain a combination of various hardware, software and networking components. These components may include, but are not limited to: one or more client devices; one or more application servers, one or more database servers; one or more web servers; one or more relational databases or other large data storage device; a web portal; one or more communication technologies such as for example, various I/O devices and other related peripherals, public or private networks, both wired and wireless, local area networks (LAN), and wide area networks (WAN); and various software components including coded algorithms, etc.

In one embodiment, the system provides the user with the ability to purchase a form of insurance to protect themselves against future volatility in the price and/or availability of desired event tickets. A user who purchases the insurance will be compensated if the system's prediction is incorrect. The accuracy of the prediction is determined by tracing over time the average selling price of the event ticket on the secondary market, and in some embodiments, as a ratio of the face value of the event ticket. Users may be given the ability to purchase different levels of insurance wherein the pricing of such insurance is based on the system's confidence in its own prediction, as the system is capable of evaluating the accuracy of its predictions. This accuracy assessment provides the user with the likelihood that the prediction will be accurate within a certain range. The precise nature of the forecast can take various forms in different embodiments, including the direction, magnitude and timing of changes in pricing and availability.

In another embodiment, the system allows the user to purchase an option to purchase a ticket to a desired event in the future at a designated price. For example, if a ticket currently costs approximately $80 on average, and the system predicts that the price will drop to approximately $40, the user could purchase an option to buy the ticket at $60 at a designated future date, regardless of how the price moves. The system may also act, for a fee, as an intermediary between a buyer and a seller of such an option. In this case, the option seller is liable to provide the ticket to the option buyer at the agreed upon option price.

In yet another embodiment, the system may, based on the prediction that the cost of a particular user-requested ticket will decrease, offer the user the ability to purchase the ticket at a cost lower than that currently offered on the secondary market, and deliver said ticket at a time in the future. In this scenario, the system bears the risk of an incorrect or inexact prediction. For example, if the lowest purchase price is currently $200 but the system predicts that the purchase price will decrease to $100, the system can offer the user the ability to buy tickets at the current time for $150, and then deliver the purchased tickets to the user at a later date. If the prediction is incorrect and the ticket price only drops to $175, then the system bears the $25/ticket loss.

In still another embodiment, the system allows users to input their actual historical purchases and/or sales and analyze how much they could have saved by optimally timing their purchase and/or sales.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A method for providing a user with a substantially accurate price forecast for at least one future event ticket on a secondary market and providing the user with a predicted optimal time in which to purchase or sell the at least one future event ticket so that the purchase price is minimized or the selling price is maximized, the method comprising the steps of:
using economic and non-economic data to determine and save a daily availability and price forecast for a plurality of future events;
receiving a user request identifying at least one future event for which the user is interested in purchasing or selling at least one ticket;
accessing the saved daily availability and price forecast for the at least one future event;
providing the user with a current availability and price forecast for the at least one future event and indicating whether the at least one future event ticket should be purchased or sold at the present time or at sometime in the future;
providing the user with a list of secondary market offers for the at least one future event ticket;
if the price forecast indicates that the at least one future event ticket should be purchased or sold at the present time, providing the user with the ability to purchase or sell the at least one future event ticket; and
if the price forecast indicates that the at least one future event ticket should be purchased or sold at a later date, providing the user with the opportunity to receive a communication alert when the ticket reaches a predicted lowest purchase price or predicted highest selling price.

2. The method of claim 1, wherein the non-economic data may include: the date, time and day of the week in which the future event will be held; a predicted weather forecast for the day of the future event; a time between the ticket sale and the future event; team performance metrics; or a current demand for the future event ticket.

3. The method of claim 1, wherein the economic data may include: the price of the at least one event ticket on the primary market; historical sales transaction data; current price of the at least one event ticket on the secondary market; previous high and low event ticket sales on the secondary market for event tickets offered for the same event in other locations or at other times.

4. The method of claim 1, wherein the economic and non-economic data is obtained in part by web bots that search the internet on a periodic basis to locate and collect information relevant to event ticket prices.

5. The method of claim 1, wherein the user request may include search criteria selected from the following: sports team name; artist or group name; name of event; venue or city.

6. The method of claim 1 further including the step of providing the user with a display of an interactive map of a venue's seating arrangement, a historical price graph, and an average secondary market ticket price.

7. The method of claim 1 further including the step of offering the user an opportunity to purchase a form of insurance against an incorrect prediction of an optimal time at which to purchase tickets at the lowest possible purchase price.

8. The method of claim 1 further including the step of offering the user an opportunity to purchase an option to purchase the at least one event ticket in the future at a designated price.

9. The method of claim 1 further including the step of offering the user an opportunity to purchase the at least one event ticket at a cost lower than the lowest current price on the secondary market.

10. The method of claim 1 further including the step of offering the user the ability to give the system permission to automatically purchase the at least one event ticket once it reaches a predetermined user-specified price.

11. A system for providing users with a future price and availability forecast for event tickets on the secondary market, the system comprising:
means for searching the internet to locate and collect information relevant to events and event ticket sales;
at least one data storage device for saving and storing collected information relevant to events and event ticket sales for a plurality of events;
means for determining the availability and future pricing trend of event tickets on the secondary market; and
a website which provides means for interacting with one or more users by providing users with the ability to search for, select or enter a particular event, request current availability and pricing information for the event, receive event information and provide means by which to purchase tickets to the event.

12. The system of claim 11, wherein the website additionally provides the user with the ability to purchase an option to purchase an event ticket in the future for a designated price.

13. The system of claim 11, wherein the website further provides an opportunity for the user to purchase a form of insurance against an incorrect prediction of an optimal time at which to purchase tickets at a lowest possible purchase price.

14. The system of claim 11, wherein the system is programmed to forecast an optimal time to purchase event tickets at a lowest possible cost.

15. The system of claim 11, wherein the system is programmed to forecast the optimal time to sell event tickets in order to obtain the highest possible price.

16. The system of claim 11, wherein the website is operative to provide the user with an ability to set up an alert wherein the system will notify the user at a later time of a predicted optimal time at which to purchase one or more event tickets at a lowest possible price.

17. The system of claim 11 further comprising means for allowing the system to evolve behaviors based on previous price predictions thereby increasing the systems ability to accurately predict future event ticket prices.

18. An event ticket predictive pricing and acquisition system that, upon a request from a user, provides a current price and availability information for one or more future event tickets on a secondary market and provides the user with an optimal time at which to purchase the one or more future event tickets in order to minimize cost, the system comprising:
means for gathering and storing historical sales data for tickets for a plurality of future events;
means for gathering and storing non-sales data that may affect the price of tickets for a plurality of future events;
means for determining a daily forecast of the future availability and price trajectory of tickets for the plurality of future events;
means for providing the user with the daily forecast for the one or more future event tickets;
means for providing the user with the option to purchase tickets for the one or more future events from the secondary market; and
means for providing the user with the option of setting up a system alert which will notify the user when tickets for the one or more future events have reached a predicted price minimum.

19. The event ticket system of claim 18, programmed to allow the user to request information on events held in a particular city, events involving a particular sports team or musical group or artist, or events held in a particular venue.

20. The event ticket system of claim 18, wherein the system further comprises means for charging the user a fee for providing the daily forecast.

21. The event ticket system of claim 18, wherein the system further comprises means for providing ticket brokers or other secondary ticket sellers with an optimal time period for buying and selling event tickets so that profit is maximized.

22. The event ticket system of claim 18, wherein the system further comprises means for offering the user the ability to purchase an option to purchase one or more event tickets in the future at a pre-determined price.
